(19) United States
(12) Patent Application Publication
(10) Pub. No.: US 2007/0193318 A1
(43) Pub. Date: Aug. 23, 2007

(54) Consumer product dispensing system

(76) Inventors: Alex Churchill, Gastonia, NC (US); Mark Romanik, Winston-Salem, NC (US); Jeff Hienz, High Point, NC (US); Leslie McCraw, Winston-Salem, NC (US)

Correspondence Address: KILPATRICK STOCKTON LLP, 1001 WEST FOURTH STREET, WINSTON-SALEM, NC, 27101, US

(21) Appl. No.: 11/699,544

(22) Filed: Jan. 29, 2007

Related U.S. Application Data
(60) Provisional application No. 60/763,167, filed on Jan. 27, 2006.

(51) Int. Cl. E05B 11/00

(52) U.S. Cl. 70/389

(57) ABSTRACT

A consumer product dispensing system and method may include a product dispensing unit having a plurality of vending compartments. Each compartment may be adapted to contain a consumer product and may be accessible through a separate door secured with a lock. A single use access mechanism attached to each door may allow a customer to unlock the lock for a one-time access to one of the vending compartments. Once the lock is unlocked, subsequent unlocking of the lock may be prohibited until the lock is reset. The single use access mechanism may include a key capture lock system and a single use access mechanism actuating element such as a key. Such a system and method may be useful for dispensing consumer products at a location remote from the point of sale.

### CROSS-REFERENCE TO RELATED APLICATIONS

This application claims priority to co-pending U.S. Provisional Patent Application No. 60/763,167, filed Jan. 27, 2006, which is incorporated by reference herein in its entirety.

### FIELD OF THE INVENTION

The present invention relates to a consumer product dispensing system and method and, in particular, to a compressed gas tank dispensing system and method.

### BACKGROUND OF THE INVENTION

Some consumer products may be dispensed from a location remote from the point of sale. For example, a tank of compressed gas, such as propane, may be secured for safety purposes outside a retail store at a distance from a checkout location. Sale of a tank of compressed gas may involve the exchange by a customer of a return (often empty) tank for a full tank. Sales transactions in which a product is dispensed remotely from the point of sale may be managed in various ways. For example, a store clerk may go to the remotely located product and dispense the product manually, or a customer may obtain the product from an electronically or mechanically operated vending system without the assistance of a store clerk.

In a store clerk dispensing system, a customer may take a return gas tank to the dispensing location outside a store. Whether or not the customer has a return tank, the customer enters the store and pays for a full tank. The customer must then wait for a store clerk to exit the store to exchange the old tank and/or dispense a full tank. This system has disadvantages for both the customer and the store. The customer is dependent on the store clerk—who may not exit the store immediately—to complete the transaction. The store clerk must take time away from the in-store business, leaving a reduced number of clerks, if any, within the store to service other customers.

In some dispensing systems, the tank storage unit may have a single door enclosing all tanks. Rather than leave other in-store customers, the clerk may give the customer the key for the single door and allow the unescorted customer to retrieve a tank from the locked storage unit. In this situation, the customer has access to the entire inventory and could take more than the number of full tanks for which the customer paid and/or not place a return tank in the storage unit. Thus, this approach may decrease inventory control and lead to loss of product (product shrinkage).

Conventional electronic vending systems may provide some automation to vending propane tanks at a location remote from the point of sale and thus overcome some of the disadvantages of a store clerk dispensing system. In one electronic vending system, for example, a customer may insert a credit or debit card into an electronic card reader; when the card is authorized, a door opens to give the customer access to a full tank. The customer may purchase a full tank or exchange a return tank for a full one. If a return tank is exchanged, a sensor in the floor of the vending compartment may verify the presence of the returned tank by sensing its weight. Such an electronic vending system avoids the waiting associated with interactions with a retail store clerk, as well as makes full propane tanks available for purchase after store hours.

However, a conventional electronic vending system for compressed gas tanks has several important disadvantages. For example, automated electronic vending systems are often relatively complex and expensive to provide and service. Door locks and floor sensors may involve pneumatic, fluid, and/or other controls. Electronic components, including the card reader, must often be kept separate from the tank vending unit so as to avoid emission of sparks from the electronics that could cause tanks to explode. In certain electronic systems for sensing return tanks, a customer may place an object in an empty compartment that has a weight similar to an empty tank and thereby make a fraudulent transaction. Card reader systems often do not allow cash transactions, and if they do, then cash security may become a problem. In addition, an automated vending system may decrease customer traffic inside a store.

Mechanical vending systems for tanks of compressed gas may be less complex and less expensive than electronic systems. In one conventional mechanical system, a customer may purchase a token from a store clerk, and deposit the token into a token slot in a vending unit, causing the door of the vending unit to open. The tank vending unit may include a single door locked about the entire inventory of tanks. In this situation, inventory control is diminished because the customer could remove more tanks than were purchased. In addition, if an empty tank is placed into the vending unit by a previous customer, the new customer may accidentally remove an empty tank instead of a full tank. These inventory control problems may be addressed by vending each tank from a separate compartment and having a unique token for each compartment. However, such a system would require maintaining control of each unique token so that the individual doors could be opened by subsequent customers. In addition, each retailer may prefer to use tokens unique to it so that customers would be able to vend tanks only from the location form which they are purchased. The number of unique tokens available may be limited such that scaling such a token system across retailers may be difficult.

Instead of a token, a mechanical vending system may utilize one or more keys to provide access to a purchased tank. In one conventional mechanical vending system, for example, a locker-type vending apparatus may have multiple compartments. Each compartment may be locked by a separate door that may be opened with a universal key. A customer may pay a store clerk for a full tank, receive the universal key from the clerk, take the key to the vending locker, open a door of the customer's choosing, remove the full tank from the locker, place a return tank in the locker if part of the transaction, and return the key to the store clerk. This system has the disadvantage of the customer with the universal key having access to the entire inventory in the lockers, and the customer having to return the key to the store clerk. Also, if an empty tank had been placed by a previous customer into the selected locker, the new customer may unknowingly remove an empty tank instead of a full tank.

In conventional vending systems in which a separate key is utilized for each of multiple vending compartments, control of multiple keys must be maintained. To manage control of multiple locker keys, public facilities such as gyms and airports may utilize a locker system with a “captured” key mechanism. In such a system, the locker key may be secured in the keyhole until a user inserts payment, for example, in the form of coins. Once payment is inserted, the key may be released from the keyhole, and the user may lock the locker and remove the key. When the user reinserts the key to unlock the locker and gain access to stored items, the key may be captured by the keyhole until another payment is inserted by the next user. A gym locker key capture mechanism may function to capture a key prior to use of the locker and to allow a user to take the key for later access of the locker. Such conventional key capture mechanisms may be unsuitable for control of keys during a vending transaction of a consumer product.

### SUMMARY OF THE INVENTION

Embodiments of the present invention may provide a consumer product dispensing and/or exchange system and method. In an illustrative embodiment, a consumer product dispensing system may comprise a consumer product dispensing unit including a plurality of individual vending compartments. Each compartment may be accessible through a separate door secured with a lock. A consumer product, for example, a compressed gas tank, may be stored in and dispensed from each compartment. The dispensing unit may be located remotely from the point of sale/purchase of the product(s) stored in the vending unit compartments, for example, outside a retail store.

Each door may include a single use access mechanism that allows a customer to unlock the lock for a one-time access to one of the vending compartments. Some embodiments may include a lock reset mechanism adapted to reset the lock to allow subsequent use of the lock and access to that vending compartment. In certain embodiments, the single use access mechanism may comprise a key capture lock system that captures a key after the door is unlocked. The key may be used only once by a consumer. The key may be released via a key release mechanism, or other reset mechanism, by an authorized person to allow for reuse of the key and compartment by a subsequent customer and/or for replenishment of the product in the vending compartment. Such a consumer product dispensing system may be utilized for selling products with or without exchange of a return product. Some embodiments of the present invention may include a method for dispensing and/or exchanging a consumer product. A consumer product dispensing system and method according to the present invention may provide for efficient retail sales transactions and inventory control of products dispensed remotely from the point of sale.

In some embodiments, a consumer product dispensing system may comprise a construction that may facilitate modular arrangement of a plurality of the dispensing units in a variety of configurations useful in retail settings.

Features of a consumer product dispensing system and method of the present invention may be accomplished singularly, or in combination, in one or more of the embodiments of the present invention. As will be realized by those of skill in the art, many different embodiments of a consumer product dispensing system and method according to the present invention are possible. Additional or alternative uses, objects, advantages, and novel features of the invention are set forth in the detailed description that follows and will become more apparent to those skilled in the art upon examination of the following or by practice of the invention.

### BRIEF DESCRIPTION OF THE DRAWINGS

FIG. 1 is a front view of a consumer product dispensing, or vending, unit comprising a plurality of individual compartments each locked by a separate door and useful for receiving returned products and for dispensing newly purchase products in one embodiment of the present invention.

FIG. 2 is a view of the left side of the embodiment of the consumer product dispensing unit shown in FIG. 1, showing vending unit connector slots and a hinge connected to an outer door.

FIG. 3 is a perspective view of the inside of two inside doors and an outer door in open position of the embodiment of the consumer product dispensing unit shown in FIG. 1, showing a key capture lock mechanism.

FIG. 4 is an enlarged view of one of the outer hinges shown in the embodiments of the consumer product dispensing unit shown in FIGS. 1-3, showing the outer door in open position.

FIG. 5 is a perspective view of an outer door of the embodiments of a consumer product dispensing unit shown in FIGS. 1-3 in closed position, the inner door in open position, and showing a strike plate attached to the outer door.

FIG. 6 is an enlarged view of a dual lock key capture mechanism shown in the embodiments of a consumer product dispensing unit shown in FIGS. 1 and 3.

FIG. 7 is a perspective view of one configuration of four consumer product dispensing units, each unit having six vending compartments, in an embodiment of the present invention.

FIG. 8 is a perspective view of another configuration of four consumer product dispensing units, each unit having six vending compartments, in an embodiment of the present invention.

FIG. 9 is a diagrammatic view of various arrangements of consumer product dispensing units in embodiments of the present invention.

FIG. 10 is a diagrammatic view of various arrangements of consumer product dispensing units in embodiments of the present invention.

FIG. 11 is a front view of a consumer product dispensing unit comprising a plurality of individual compartments each locked by a separate door and useful for receiving returned products and for dispensing newly purchase products in another embodiment of the present invention; one of the compartment doors is shown absent to reveal a compressed gas tank inside the compartment.

FIG. 12 is a view of the right side of the embodiment of the consumer product dispensing unit shown in FIG. 11, having one of the compartment doors on the side of the unit absent to reveal a compressed gas tank inside the compartment.

FIG. 13 is a front view of the embodiment of a consumer product dispensing unit shown in FIGS. 11 and 12, having some of the compartment doors removed to reveal the spatial arrangement of the front and side compartments.

FIG. 14 is a side view of a dual lock key capture apparatus useful in an embodiment of the present invention.

FIG. 15 is a front view of the embodiment of a dual lock key capture apparatus shown in FIG. 14.

FIG. 16 is an internal view of the embodiment of a dual lock key capture apparatus shown in FIGS. 14 and 15.

FIG. 17 is a front view of a directional sign useful with a consumer product dispensing unit in an embodiment of the present invention.

### DETAILED DESCRIPTION

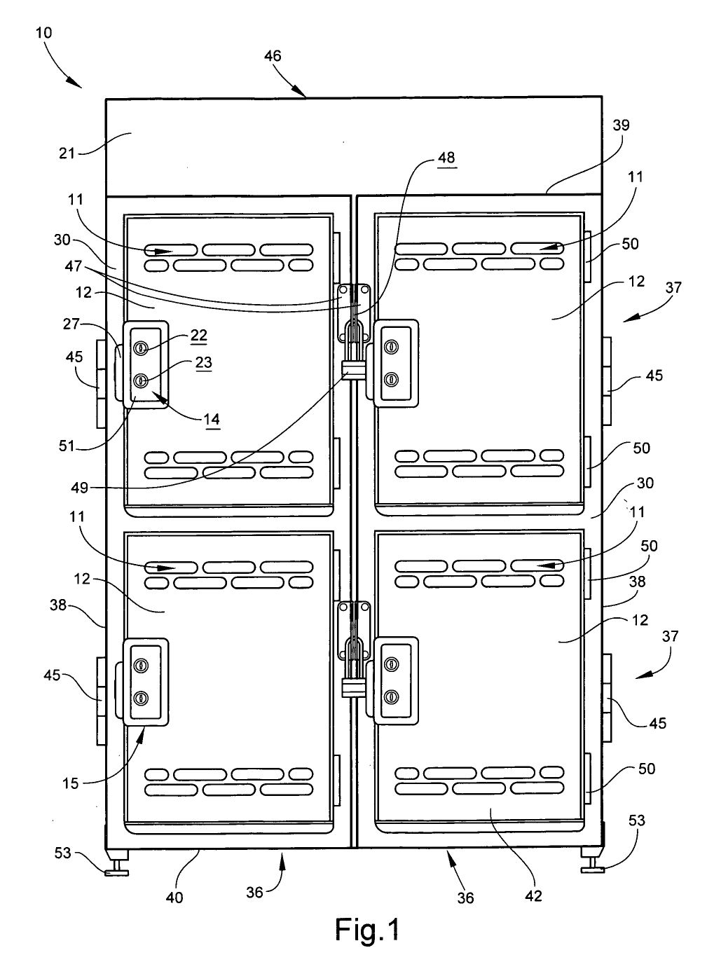

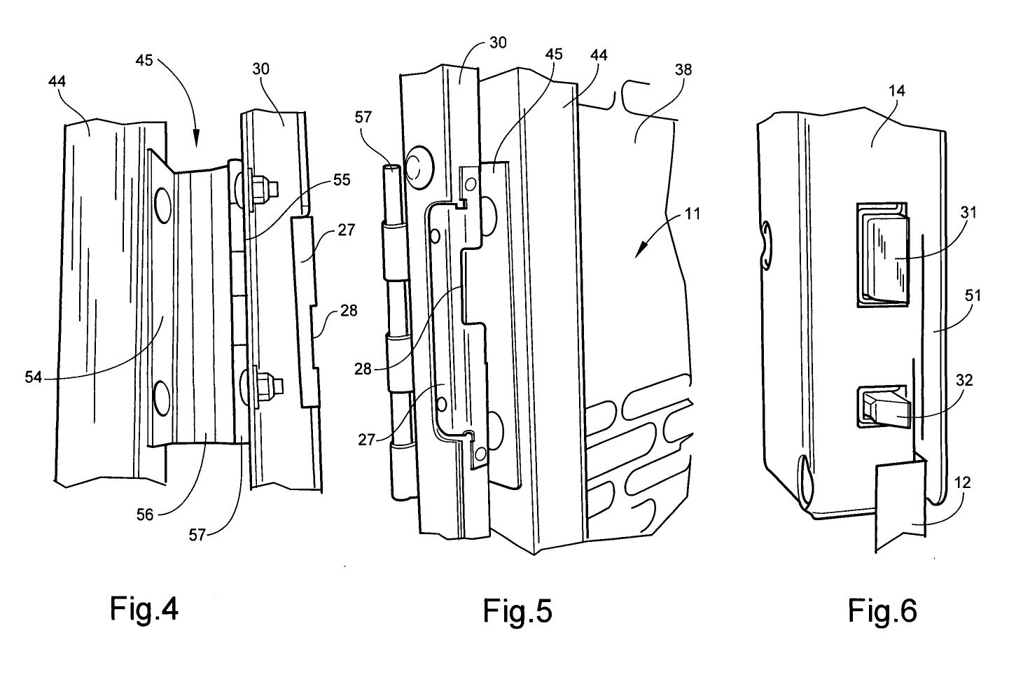

FIGS. 1-17 illustrate embodiments of a consumer product dispensing system and/or method of the present invention. In an illustrative embodiment, a consumer product dispensing system may comprise a consumer product dispensing unit, or vending unit, 10 including a plurality of individual vending compartments 11. Each compartment may be accessible through a separate locked covering, such as a door 12. The door 12 may be pivotably mounted to the dispensing unit 10 adjacent the compartment 11. A consumer product, for example, a tank of compressed gas 13, may be stored in and dispensed from each compartment 11. The dispensing unit 10 may be located remotely from the point of sale/purchase of the product(s) in the dispensing unit compartments 11. For example, the product dispensing unit 10 may be located outside a retail store at a distance from a checkout counter.

In some embodiments, each door 12 may include a single use access mechanism that allows a customer a one-time access, or use, of a particular product compartment 11. In this manner, a customer may gain access to only the product stored in that dispensing unit compartment 11. Accordingly, customers may be prevented from removing more units of the product from the dispensing unit 10 than the number of accesses that are purchased. Such a consumer product dispensing system may be utilized for selling products with or without exchange of a return product.

The single use access mechanism may comprise various components, configurations, and modes of operation. For example, in certain embodiments, the single use access mechanism may comprise a key capture lock system 14 that captures a key after the door 12 is unlocked. In such a system, the key may be used only once by a customer. In certain embodiments, the key may be released via a key release mechanism 15, or other reset mechanism, by an authorized person to allow for replenishment of the product in the vending unit 10 and for re-use of the key and vending compartment 11 by a subsequent customer.

An embodiment of the present invention may be useful for efficiently exchanging various types of consumer products. An embodiment of the present invention is particularly adaptable for consumer purchases and/or exchanges of a tank of compressed gas 13, for example, a tank of propane gas. Such propane gas tanks 13 may be used in many applications including, for example, with gas barbeque grills, patio heaters, portable heaters, turkey fryers, mosquito killers, and other appliances.

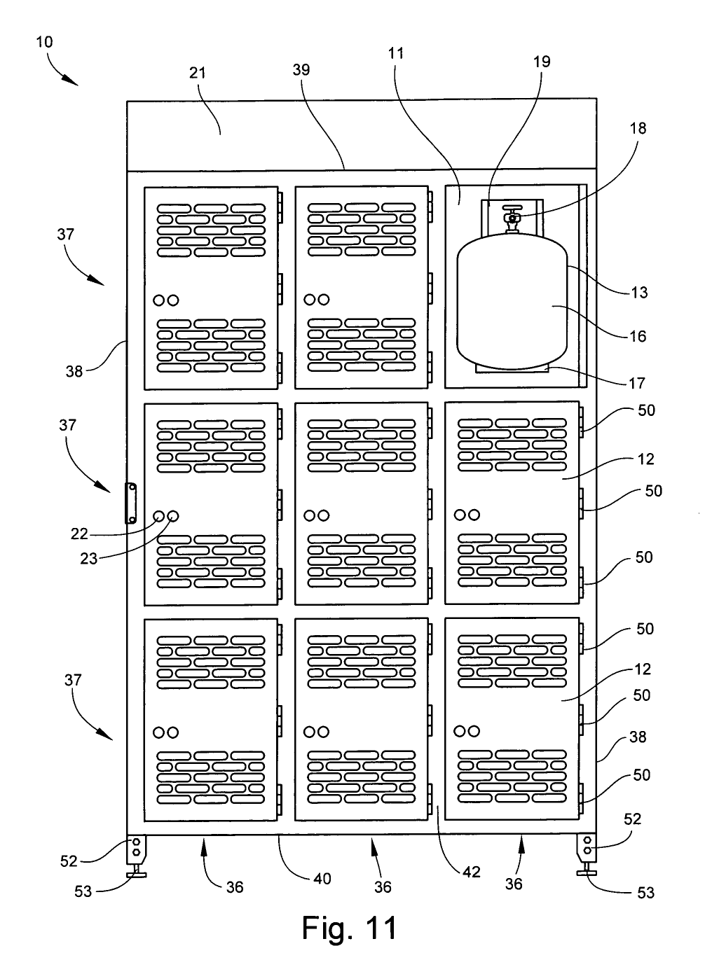

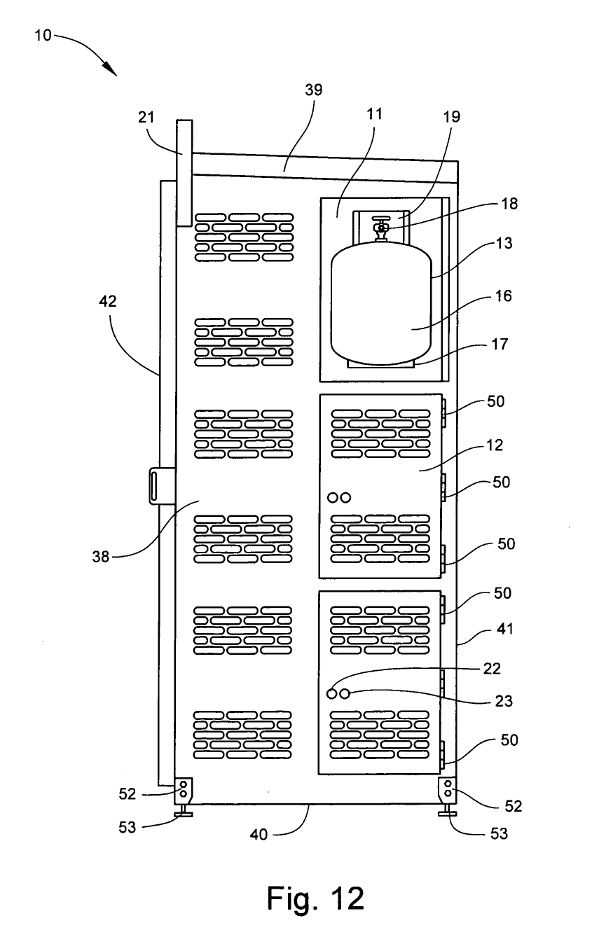

Propane is a liquefied petroleum gas and may be stored in a variety of tanks for use in industrial and residential use. Upon exiting the pressurized tank, the propane changes state from a liquid to a gas. The U.S. Department of Transportation has established standards for the tanks which are referred to as D.O.T. containers or cylinders. As shown in FIGS. 11 and 12, one such tank may include a cylindrical and hollow main body 16 having a rounded bottom end resting upon and fixedly attached to a support ring 17. The support ring 17 may provide a base for tank to rest upon a surface. Propane within the tank may be controllably released via a standard gas valve 18 mounted on top of the tank. A valve safety wall, or collar, 19 may be fixedly mounted on top of the tank 13 and may partially surround the valve 18. In certain embodiments of the present invention, vending unit compartments 11 may be sized to safely accommodate tanks 13 configured in such a manner.

In a transaction for purchase and/or exchange of a consumer product such as a tank of compressed gas 13, a customer (consumer) may bring a return product (tank) 13 to a retail store and pay a store clerk the price for a full tank 13 in exchange. The exchange tank 13 may be empty or still have residual gas in the tank 13. The price for a purchase transaction in which tanks 13 are exchanged may be lower than the price for purchase of a full tank 13 without an exchange. The tanks 13 in which compressed gas are delivered may be more valuable than the product in the tank 13. As a result, control of an inventory of such tanks 13 may be commercially important. Thus, when such products are dispensed at a location remote from the point of sale, it may be commercially important that a genuine return tank 13 is provided by the customer before a full tank 13 is delivered to the customer. To confirm that the transaction involves an exchange, the store clerk may verify that the customer has a return tank 13. If the customer does not have a return tank 13, the store clerk may charge the customer for a replacement tank 13 and gas at a higher price. This verification of a return tank 13 may prevent the customer from paying the lower price and obtaining a tank 13 without exchanging a return tank 13 for it. Upon payment by the customer, the store clerk may give the customer an element for actuating a mechanism that may allow a single access of one compartment 11 in the dispensing unit 10. For example, the store clerk may give the customer a customer key 24 that allows the customer a one-time access to a full tank 13 from a single compartment 11 in the vending unit 10.

In some embodiments of the present invention, a retail store may include an in-store display for a consumer product remote from the dispensing unit 10. Such an in-store display may include advertisement information related to the product, product information, and/or materials related to how to purchase the product. For example, the in-store display may include tickets for each type of transaction (exchange transactions and non-exchange transactions). A customer may obtain a ticket from the display while shopping in the store and take the ticket to the check-out counter to pay for the transaction. The tickets may include a bar code that is coded for the type of transaction. Once the customer pays for the transaction, and the store clerk verifies the presence of an exchange product, if needed, the store clerk may give the customer a single use access element, such as a first, or customer, key 24. After receiving the customer key 24, or other single use access element, the customer may take the return product, such as a tank 13, (if exchanging products) and the key 24 to the dispensing unit 10 remote from the point of sale. The customer may then select a door 12 to open. Doors 12 available for opening may be identified by the absence of a key 24 captured in the lock of the door 12.

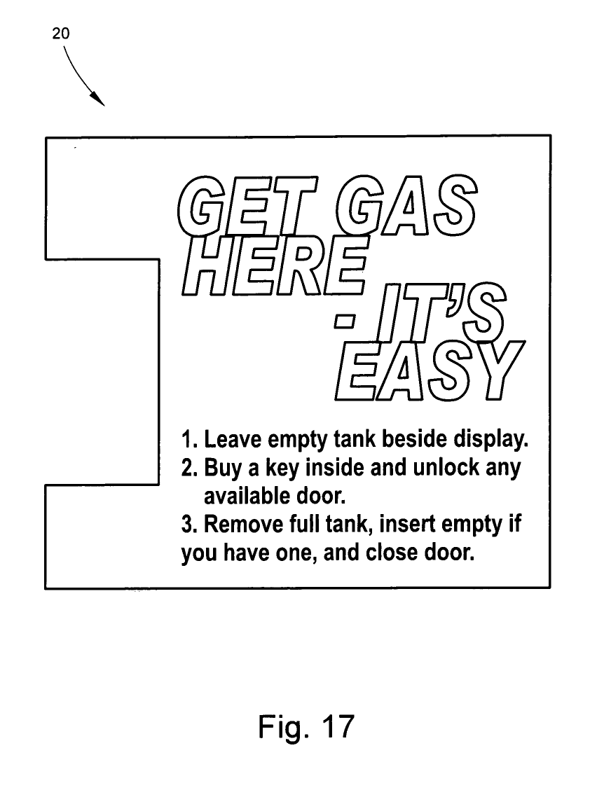

Instructions for removing a full tank 13 from a dispensing unit compartment 11 and, if needed, placing a return tank 13 in exchange in the compartment 11 may be provided by signage 20 at the point of sale in the store and/or on or near the dispensing unit 10. As shown in the embodiments in FIGS. 1, 7-8, and 11-13, the dispensing unit 10 may include a signage header 21 extending vertically upward from the top of the vending unit 10. The signage header 21 may include advertising information, price information, and/or instructions for retrieving a full tank 13 and exchanging tanks 13. In some embodiments of a dispensing unit 10, signage 20, such as the embodiment of signage 20 shown in FIG. 17, may be displayed on the signage header 21 and/or on one or more individual compartment doors 12 on the dispensing unit 10. In addition, such instructions may be provided orally by the store clerk to the customer and/or by a card given to the customer with the customer key 24.

Once a vending compartment door 12 available for access by a customer has been identified, the customer may use the single use access actuating element provided by the store clerk to access the compartment 11. For example, in an embodiment utilizing a key capture lock system 14, a customer may identify a door 12 without a captured key 24 as available for access. The customer may insert the customer key 24 into a customer lock 22 of the selected door. In a key capture lock system 14, the customer lock 22 on each door 12 may be labeled or otherwise identified as the customer lock 22.

In an embodiment of the present invention including a key capture system 14, the customer key 24 may be turned to unlock the customer lock 22, which may cause the key 24 to be captured in the lock 22. As the customer key 24 is turned in the customer lock 22, the strike 31, or plunger, of the lock 22 may be disengaged from the strike receptacle 28. When the key 24 is turned an amount sufficient to move the strike 31 away from the strike receptacle 28 such that the door 12 is free to open, the key 24 may stop turning. In one embodiment of a key capture system 14, in order for the door 12 to be opened, the customer key 24 must be held in the “unlocked” position for the strike 31 of the customer lock 24 to remain disengaged from the strike receptacle 28. In various embodiments, the stopped movement of the key 24 may provide a queue to the customer to open the door 12. The customer may pull on the captured key 24 to pull the door 12 open. In this manner, the captured key 24 may serve as a handle means. The customer then has access to inside the vending unit compartment 11.

In some embodiments, the door lock 22 may include a spring (not shown) or other biasing mechanism. Once the door 12 is opened and the customer releases the key 24, the spring or biasing mechanism may move the strike 31 outward from the lock 22 into its original “locking” position. The outward biasing of the strike 31 may help maintain the door 12 in the open position once the customer lock 22 is unlocked and the door 12 is pulled open. In addition, the mechanical tolerance between the edge of the lock 22 on the door 12 and the strike plate 27 may be sufficiently tight so as to prevent accidental closing of the door 12 merely from the weight of the door 12 as it swings freely. Alternatively, or in addition, a suitable spring mechanism (not shown) may be provided on the door hinge 50 to bias the door 12 in the open position once the customer lock 22 is unlocked and the door 12 is pulled open.

Once the door 12 is open, the customer may then remove the product, such as a full tank of gas 13, from the vending compartment 11. If the customer is exchanging tanks 13, the return tank 13 may be placed in the compartment 11 after the full tank 13 is removed. Signage 20 may be provided inside the compartments 11 to remind customers to place a return tank 13 into the compartment 11 before closing the door 12. Finally, the door 12 may be closed to complete the transaction.

In an embodiment of a lock 22 having a strike biasing mechanism, when the door 12 is closed, the strike 31 may engage the strike receptacle 28 such that the door 12 may be automatically locked. In an embodiment having a key capture lock system 14, the customer key 24 may remain captured in the closed and locked door 12. That is, once the key 24 is captured in the lock 22, it may not be turned again to open the lock 22. In this manner, a return product, such as a compressed gas tank 13, may be secured in the vending compartment 11. The key 24 may remain in the door 12 after the door 12 is opened and closed as an identification that the compartment 11 has already been used for a transaction. The captured key 24 may prevent a subsequent customer from opening the door 12 and accidentally removing a returned tank 13 from the vending compartment 11.

In an embodiment of a dispensing unit 10 having a key capture system 14, the lock mechanism may include a second, or retail, lock 23 adjacent to the first, or customer, lock 22. The retail lock 23 may operate to automatically lock the customer key 24 in a captured position when the customer key 24 is turned to unlock the customer lock 22. The customer lock 22 and the adjacent retail lock 23 may be configured such that unlocking the retail lock 23 will unlock the customer lock 22 and release the customer key 24. In an embodiment, the retail lock 23 may be opened with a retail, or master, key 25. The retail master key 25 may be inserted into the retail lock 23 and turned so as to release the captured customer key 24 from the customer lock 22. In certain embodiments, the customer key 24 may be removed from the customer lock 22 only with the action of unlocking the retail lock 23.

Embodiments of a dual lock key capture mechanism 26 may comprise various types of locks and operative configurations between the locks. For example, one illustrative embodiment of a dual lock key capture mechanism 26 is shown in FIGS. 1, 3, 5, and 6. In this embodiment, the frame for the inner door 12 is formed by an outer door 30. The door locking mechanism may include an upper strike 31 and a lower plunger 32. The customer lock 22 and the retail lock 23 may each be turned, or actuated, individually with its respective key to retract the upper strike 31 for opening the door 12.

As shown in FIG. 6, the upper strike 31 may be biased outwardly and adapted to engage a strike receptacle 28 in a strike plate 27 and inner door frame, or jamb (formed by the outer door 30). The surface of the upper strike 31 that projects toward the strike plate 27 may be angled such that a shorter portion of the upper strike 31 may contact the strike plate 27 first in a fashion similar to some conventional door strikes. In this way, retraction of the upper strike 31 away from the strike plate 27 may be facilitated by the movement of closing the inner door 12.

The lower plunger 32 may be biased outwardly so as to ride against the strike plate 27. The strike plate 31, as shown in FIG. 5 includes the strike receptacle 27 for the upper strike 31 but not for the lower plunger 32. As a result, the lower plunger 32 may ride against the surface of the strike plate 27 without engaging the strike plate 27 in a latching, or locking, fashion. In this manner, the lower plunger 32 may sense whether the door 12 is closed or open. In this embodiment, the customer key 24 may not be released until the retail key 25 is turned to the “unlocked” position in the retail lock 23 and the door 12 is opened. If the door 12 remains closed, the retracted lower plunger 32 may restrict the customer lock 22 from being returned to its neutral position such that the customer key 24 may be released. When the retail key 25 is turned in the retail lock 23 to retract the upper strike 31 from the strike plate receptacle 28, and the door 12 is pulled opened, the lower plunger 32 may move slightly outward, thereby sensing that the door 12 is open and allowing the customer lock 22 to be turned back to its neutral position by the retail lock 23 so that the customer key 24 may be released.

In an alternative embodiment, the customer lock 22 and retail lock 23 may be configured such that only the customer lock 22 may open the door 12 and the retail lock 23 may be used only to reset the customer lock 22 such that the customer key 24 may be released.

In particular embodiments, the upper strike 31, lower plunger 32, strike plate 27, and strike receptacle 28 may comprise metallurgical characteristics adapted to reduce or eliminate the risk of sparks related to metal-to-metal contact. For example, the upper strike 31 and lower plunger 32 may have at least a surface comprising brass, and the strike plate 27 may have at least a surface comprising stainless steel such that the risk of spark generation from closing the door 12 may be minimized.

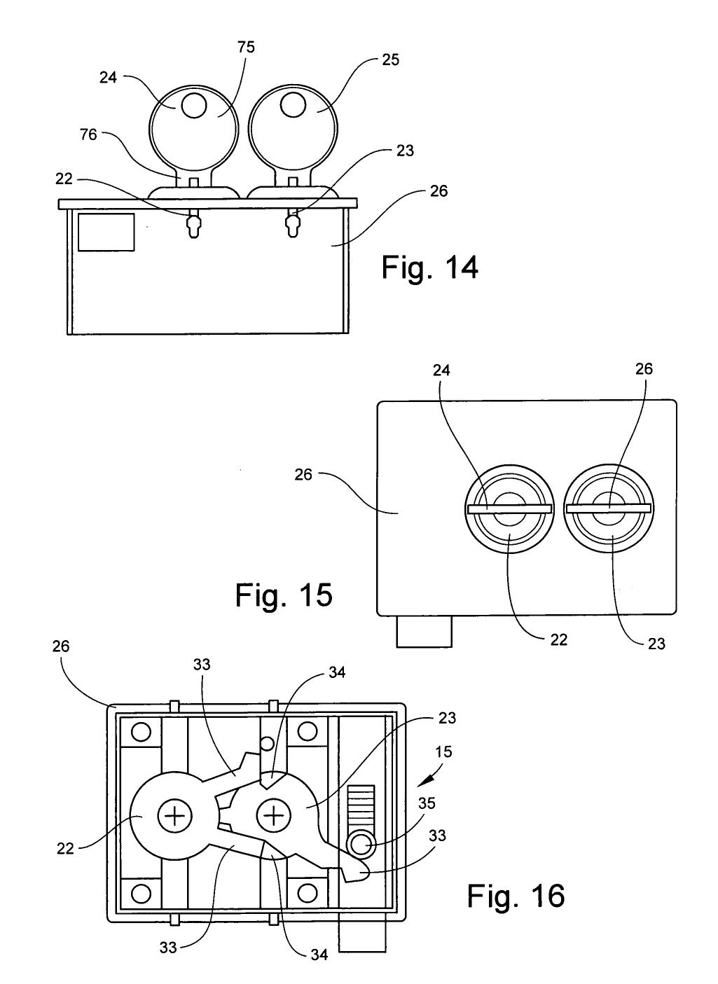

Another embodiment of a dual lock key capture mechanism 26 is shown in FIGS. 11-13, and illustrated in more detail in FIGS. 14-16. This dual lock type of key capture mechanism 26 includes a customer lock 22 and a retail lock 23 that are positioned adjacent each other. The locks 22, 23 may comprise various types of commercially available locks. For example, the locks 22, 23 may comprise a “plunger” type lock having a tumbler inside a barrel. The customer lock 22 may include one or more radial arms 33 extending radially outward from the tumbler oriented in the direction of the retail lock tumbler. The retail lock 23 may include one or more locking projections 34 disposed on its tumbler in the direction of the customer lock radial arms 33. The retail lock 23 may further include a radial arm 33 extending radially outward from its tumbler in a direction opposite the customer lock 22. When the retail lock 23 is in the “locked” position, the retail lock radial arm 33 is biased in a counter-clockwise direction against a stop pin 35. In this position, when the customer lock 22 is turned with a customer key 24 in the clockwise (unlocking) direction, the customer lock radial arms 33 are turned so as to lock into an unmovable position against the retail lock locking projections 34. In this manner, once the customer lock 22 is unlocked, its tumbler may not be moved in a counter-clockwise direction to remove the key 24, and the customer key 24 is captured in the customer lock 22. When the retail key 25 is inserted into the retail lock 23 and turned in the clockwise direction, the pressure of the locking projections 34 against the customer lock radial arms 33 may be relieved. Then, the customer lock 22 may be turned in the counter-clockwise direction so that the customer key 24 may be released.

In certain embodiments, the retail master key 25 may be able to unlock each of the compartment doors 12 in the dispensing unit 10. In this way, the store clerk or service provider may open the doors 12 of all the vending compartments 11 with one key 25 for removing returned tanks 13 for replacement. In addition, the store clerk may open any of the compartment doors 12 with the retail master key 25 to intervene in a customer transaction if needed. For example, if a customer inadvertently closes the vending compartment door 12 prior to removing a full tank 13 and/or prior to placing a return tank 13 inside the compartment 11, the store clerk may open the door 12 so that the full tank 13 may be removed and/or the return tank 13 properly placed inside the compartment 11.

Another embodiment of a dual lock type of a key capture mechanism 26 may include a customer lock 22 and a retail lock 23 that are positioned adjacent each other. In this embodiment, the customer lock 22 may comprise a “latch and pin” locking mechanism (not shown). The lock 22 may include a latch extending in the direction of the door frame adjacent the lock 22. The door frame may include a pin mounted horizontally in the door frame such that the latch may overlap the pin to lock the door 12. A customer key 24 may be inserted into the customer lock 22 and turned to move the latch away from the pin and unlock the door 12. When the customer key 24 is turned past a certain point in the lock 22, the key 24 may be captured in the customer lock 22. When the retail key 25 is inserted into the retail lock 23 and turned appropriately (in a manner similar to that described herein relative to the dual lock key capture mechanism 26 in FIGS. 14-16), the customer lock 22 may again be turned so that the customer key 24 may be released.

Some embodiments of a consumer product dispensing system may include other types of single use access mechanisms. For example, certain embodiments of a single use access product dispensing system may include a single lock mechanism (not shown) for each compartment door 12. That is, rather than a dual lock system 26 with both a customer lock 22 and a retail lock 23, each compartment door 12 may be connected to a single lock for that door 12. The single lock connected to a compartment door 12 may be accessed only once in a product exchange and/or purchase transaction. In some embodiments, the single lock may be accessed and unlocked with a customer key 24. In certain embodiments, the customer key 24 may be captured in the single lock in a manner similar to that described herein related to a dual lock key capture mechanism 26. In other embodiments, the single lock may be accessed with a tool or implement other than a key and that is uniquely designed to actuate, or unlock, the particular lock. Such a uniquely designed access element may be, for example, a token, a piece of metal, or other actuating member designed for unlocking a particular lock. As compared to a dual lock mechanism 26, a single lock mechanism may provide the advantages of lower manufacturing cost and ease of identifying the lock access point for a customer.

In embodiments of a product dispensing system, the single use access mechanism may be reset for access by customers in subsequent transactions by a reset mechanism. In certain embodiments, the product dispensing system may include a single reset mechanism for all of the compartment doors 12. For example, the reset mechanism may be a retail master key 25 that is designed to fit all compartment door locks, whether a single lock system or a dual lock system 26. In embodiments of a consumer product vending unit 10 that include a single service door or access to all compartments, or outer doors 30 containing a plurality of inner doors 12, the reset mechanism may be connected to the service door or to the outer doors 30. Alternatively, the single reset mechanism for all compartment doors 12 or for a subset of compartment doors 12 may be located inside the dispensing, or vending, unit 10 and may be accessed through the service door and/or outer doors 30.

In certain embodiments, the lock reset mechanism may have various other configurations and operative mechanisms. As an example, the reset mechanism may comprise an electronic reset mechanism (not shown) in which single use access locks 22 may be reset with a switch in an electronic circuit connected to the respective locks 22. In another embodiment, the lock reset mechanism may comprise a means of radio frequency identification (RFID). For purposes herein, RFID is defined as an automatic identification method, relying on storing and remotely retrieving data using devices known as RFID tags or transponders. A RFID tag, such as a silicon chip-based tag, is an object that may be attached to or incorporated into a product for the purpose of identification using radio waves. One or more single use access locks 22 may be programmed to be identified by a RFID lock reset device (not shown). When the RFID lock reset device is actuated, locks 22 identified by the device may be reset to a customer accessible state.

Some embodiments of a consumer product dispensing system according to the present invention may include other types of a key capture mechanism. For example, an alternative key capture system may include magnets (not shown) positioned for aligning projections of the lock(s) such that the customer key 24 may not be removed from the customer lock 22 once the customer lock 22 is unlocked and the compartment door 12 opened. The magnets may be reoriented or deactivated so as to allow the customer key 24 to be released from the customer lock 22.

Some embodiments of a consumer product dispensing system may include single use access mechanisms having components, configurations, and/or modes of operation other than a key capture system 14. In an alternative embodiment, vending compartment doors 12 may include a magnetic lock (not shown) in which a key 24 is not captured and which may be removed by the customer immediately after use. In such an embodiment, once the customer lock 22 is unlocked and the door 12 opened and then closed, the magnetic field may be oriented so as to prevent using the key 24 to reopen the door 12 until the magnetic system in the lock 22 is reset. In addition, the customer locks 22 and keys 24 may be keyed so that a key 24 may be used to access one door 12 only. Accordingly, the customer may gain access only once to a single compartment 11 using the key 24 such that control of the product inventory in the vending compartments 11 may be maintained.

In another embodiment, the single use access mechanism may comprise a card reader system (not shown) connected to a vending compartment door 12. The card reader may be configured to operate the customer lock 22 only once until the card reader is reset. For example, when a customer card is placed in the card reader, the card reader may actuate the customer lock 22 so as to unlock the lock 22. Once the customer lock 22 is unlocked, the compartment door 12 to which it is connected may be opened, and the product inside that compartment 11 may be accessed.

In some embodiments, when a customer places a card in the card reader, the card may be removed by the customer. The card may be programmed, for example, to contain indication of payment for multiple products. Accordingly, the customer may use the card to access the number of compartments 11 and product units corresponding to the number of product units for which payment has been made. In such embodiments, once the card is used to access a particular vending compartment 11, the card reader connected to that compartment 11 may prevent use of the same card or another card to reopen that compartment 11 until the card reader is reset.

In other embodiments, when a customer places a card in the card reader, the card may be captured in the card reader-customer lock assembly until released by a release mechanism. The release mechanism may be, for example, a retail card insertable into the card reader or a retail key 25 usable in the retail lock 23 connected to the card reader. Such customer and/or retail card readers may include a low voltage battery to operate the card reading and/or door opening functions. A low voltage direct current (DC) battery may minimize, or eliminate, the risk of spark emissions associated with locking systems that are powered by alternating current (AC) or that are controlled totally by electronics.

A card reader-lock system may include a mechanism for indicating that a compartment 11 connected to the card reader is unavailable for customer access. For example, after a first customer has accessed a compartment 11 via a card reader, the card reader may display an electronic, mechanical, and/or other indicator that the compartment 11 is not available for access by a subsequent customer. An electronic indicator may be any of a variety of electronic indicators, such as an LED light that illuminates an “X” sign, or a light of a particular color, for example, red, to indicate that the compartment 11 is unavailable. A mechanical indicator may be any of a variety of mechanical indicators, for example, a sign stating that the compartment 11 is unavailable that is displayed when the compartment 11 has been previously accessed and not ready for customer use.

In another embodiment, the single use access mechanism may comprise a numerical key system and keypad (not shown) connected to a vending compartment door 12. When payment is made for purchase of a product, the customer may obtain a numerical code that may be keyed on the keypad into the numerical control system so as to unlock the lock 22 associated with a single compartment door 12. Once the numerical code has been used to access the compartment 11, that code may not be reused to reopen that compartment door 12 or the door 12 of any other compartment 11. In this manner, the customer is limited to a single access of that compartment 11. Such an embodiment may include a mechanism to reset codes for compartment locks 22 once specific codes have been utilized. For example, the store clerk and/or vendor representative may maintain a retail master code that may be used to reset the numerical key system to accept new codes for accessing each compartment in the product dispensing unit 10.

Access to vending unit compartments 11 may be controlled by various other types of single use access mechanisms. For example, a single use access mechanism may comprise mechanisms for utilizing finger prints, retinal patterns, biosensory information, and/or other unique identifiers to recognize an authorized customer and allow a single access to a vending unit compartment 11.

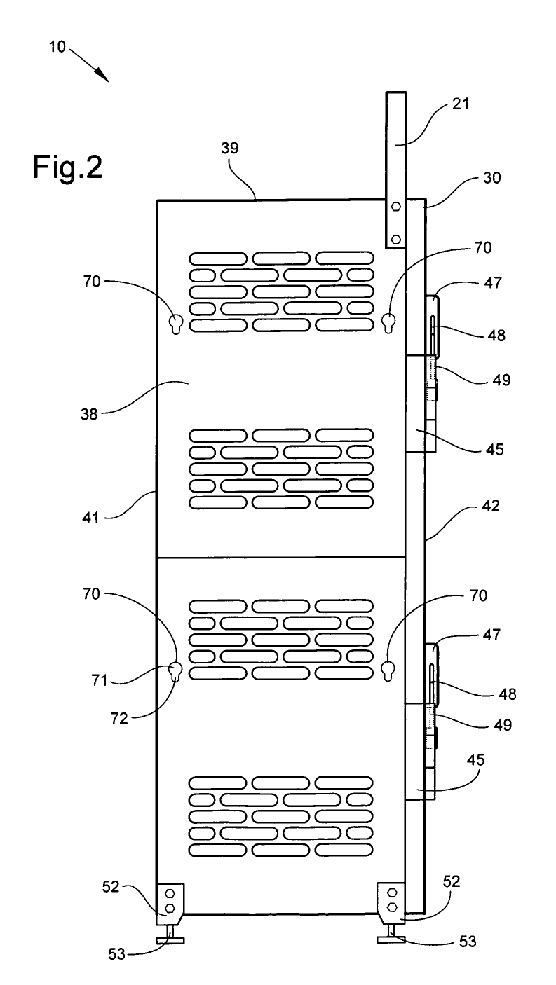

Embodiments of a consumer product dispensing system having a single use access mechanism may provide other advantages relative to conventional vending systems. As shown in the embodiment in FIGS. 1-3, the product dispensing unit 10 may comprise four vending compartments 11, arranged as two compartments 11 in each of two columns 36 and two rows 37. The dispensing unit 10 may include two sides 38, a top 39, a bottom 40, and a back 41, each of which are closed. The front 42 of the dispensing unit 10 includes four openings 43, one opening corresponding to each of the four vending compartments 11. An outer door 30 comprising a frame may be hingedly connected to the frame 44 of the side panel 38 on each side 38 of the dispensing unit 10 with a pair of outer door hinges 45. The outer door 30 may be sized to close about the perimeter of the front openings 43 of each of the two compartments 11 in a column 36. When closed, the non-hinged sides of the two outer doors 30 may be adjacent each other near the vertical center 46 of the dispensing unit 10. A mating lock bracket 47 may be securely attached to the non-hinged side of each of the two outer doors 30. When the two outer doors 30 are closed about the vending compartments 11, the lock bracket 47 on each outer door 30 may align with the mating lock bracket 47 on the other outer door 30. The mating lock brackets 47 may include an opening 48 through which an outer door lock 49, such as a padlock, may be inserted to lock the outer doors 30 together. In some embodiments, for example, as shown in FIGS. 1 and 2, the outer doors 30 may include two sets of mating lock brackets 47 and locks 49. In this arrangement, unlocking and opening the two outer doors 30 allows access to each of the four vending compartments 11 in the dispensing unit 10.

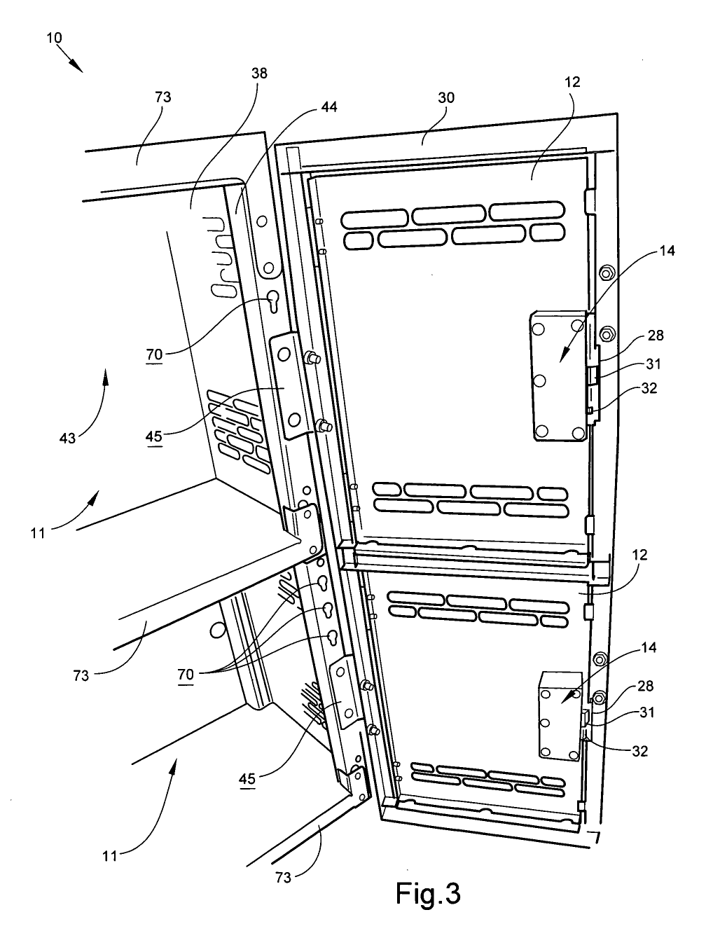

The frame structure of each of the outer doors 30 may form a frame perimeter corresponding with the front openings 43 of each of the two vending compartments 11 in one of the columns 36. An inner door 12 may be hingedly attached to the outer door 30 with a pair of inner door hinges 50 such that the inner door 12 may be opened and closed while the outer door 30 is locked. The inner door 12 may be sized to substantially cover the front opening 43 of one of the vending compartments 11 when closed. In the embodiment shown in FIGS. 1 and 3, each outer door 30 may include two inner doors 12 for covering the front opening 43 of both of the vending compartments 11 in one of the columns 36. Thus, the embodiment of a product dispensing unit 10 shown in FIG. 1 may include four inner doors 12.

Each inner door 12 may include a lock mechanism, for example, on the side of the inner door 12 opposite the inner door hinges 50. As shown in the embodiment in FIG. 1, the lock mechanism may be a dual lock mechanism 26, as described herein. One of the locks in the dual lock set 26 may be the customer lock 22 which may be unlocked with the customer key 24. A customer may obtain a customer key 24 by paying for purchase of the product in the compartment 11. In some embodiments, once the inner door 12 is unlocked with the customer key 24, the inner door 12 may not be unlocked again with the customer key 24 until the second lock, or retail master lock, 23 is unlocked. As shown in FIGS. 1 and 6, the customer lock 22/retail lock 23 dual lock set 26 may include a lockset cover plate 51 on the exterior of the inner door 12. The lockset cover plate 51 may extend slightly beyond the edge of the inner door 12 so as to help keep the inner door 12 from swinging past the point where the locks 22, 24 are aligned with the frame of the outer door 30.

In some embodiments, the dispensing unit 10 may include legs 52 to raise the bottom 40 of the unit 10 up off of the ground. Dispensing unit legs 52 may include levelers 53 for leveling the unit 10 as needed. Certain embodiments of the dispensing unit 10 may include wheels (not shown) so that the unit 10 may be moved as needed, for example, for cleaning behind the unit 10 or for re-locating the unit 10 to a different location for ease of customer access, such as when retail traffic patterns change.

In some embodiments of a product dispensing unit 10, the outer door hinge 45 may comprise a U-shaped bracket, as shown in FIGS. 3-5, for example. The U-shaped bracket may include a dispensing unit connector 54 which forms one “leg” of the U-shaped bracket and that may be connected to the dispensing unit frame 44. An outer door connector 55 may form the opposite “leg” of the U-shaped bracket and may be connected to the outer door 30 frame. An extension flange 56 which may form the “back” of the U-shaped bracket may be integrally formed on one end with the dispensing unit connector 54 and may pivotably connect on the other end with the outer door connector 55 about a pivot pin 57. Accordingly, the extension flange 56 may connect the dispensing unit connector portion 54 and the outer door connector portion 55 of the hinge 45. The extension flange 56 may comprise substantially the thickness of the outer door 30 frame such that when the outer door 30 is closed, the outer door 30 may fit firmly against the perimeter of the vending compartment front openings 43. As a result, the closure about the vending compartments 11 may be secured.

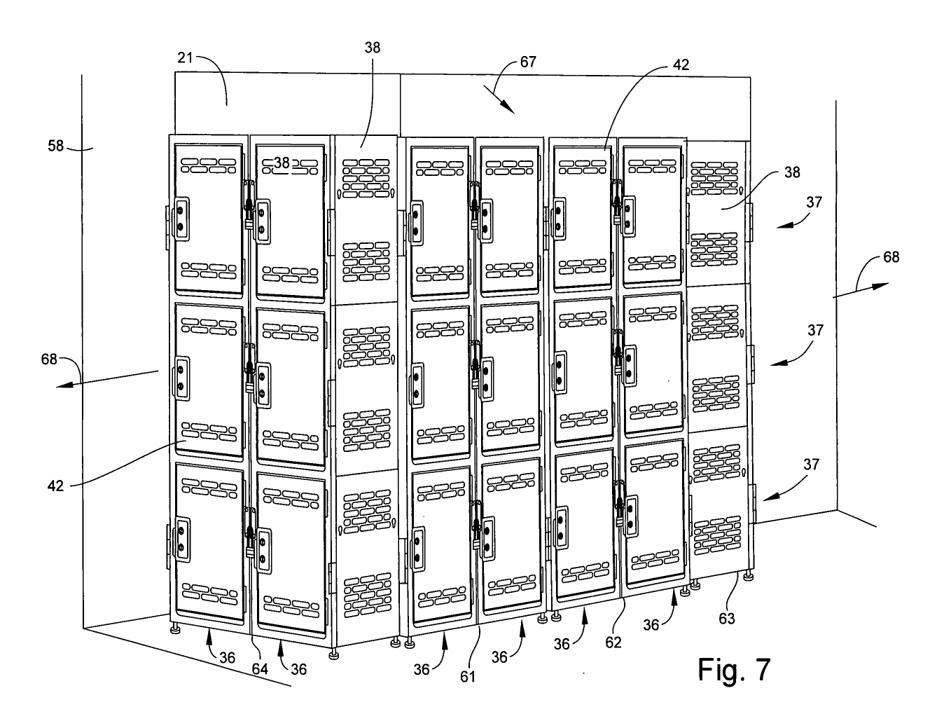

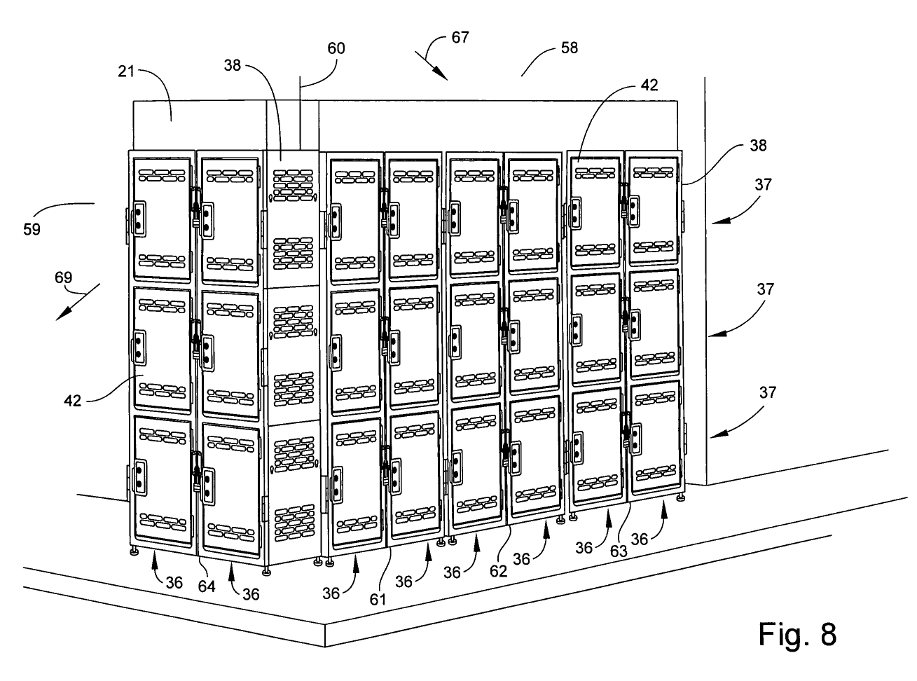

In another aspect of the present invention, embodiments of a consumer product dispensing unit 10 or system may have various other beneficial construction features. As shown in the embodiments in FIGS. 3-5, the consumer product dispensing unit 10 may comprise two columns 36 of vending compartments 11 in side-by-side relationship and two rows 37 of vending compartments 11, one row 37 on top of the other, for a total of four vending compartments 11 in the modular dispensing unit 10. As shown in the embodiments in FIGS. 7-8, the consumer product dispensing unit 10 may comprise two columns 36 of vending compartments 11 in side-by-side relationship and three rows 37 of vending compartments 11, for a total of six vending compartments 11 in the modular dispensing unit 10. In other embodiments, the dispensing unit 10 may have different numbers of vending compartments 11. In each of these embodiments, the dispensing unit 10 may be a single vending compartment 11 deep.

Such combinations of vending compartments 11 in a dispensing unit 10 allow the modular dispensing units 10 the flexibility to be arranged in a variety of display and operational configurations. For example, as shown in the embodiment in FIG. 7, four dispensing units 10 each having six vending compartments 11 may be arranged together in a retail display against a first wall 58. First and second dispensing units 61, 62, respectively, may be positioned side-by-side such that the compartment doors 12 of each of the first and second units 61, 62 face in the same direction 67 opposite the first wall 58. A third dispensing unit 63 may be placed with the back 41 of the unit 63 against the side 38 of one of the first and second dispensing units 61, 62, such that the compartment doors 12 of the third dispensing unit 63 face in a direction 68 essentially perpendicular to the direction 67 in which the doors 12 of the first and second units 61, 62 face, and essentially parallel to the first wall 58. A fourth dispensing unit 64 may be placed with the back 41 of the unit 64 against the side 38 of one of the first and second dispensing units 61, 62 opposite the third dispensing unit 63, such that the compartment doors 12 of the fourth dispensing unit 64 face in a direction 68 essentially perpendicular to the direction 67 in which the doors 12 of the first and second units 61, 62 face, essentially parallel to the first wall 58, and in a direction opposite the direction in which the doors 12 of the third dispensing unit 63 face.

In the embodiment shown in FIG. 8, four dispensing units 10 each having six vending compartments 11 may be arranged together in a retail display against the first wall 58 and a second wall 59 around a corner 60. First, second, and third dispensing units 61, 62, 63, respectively, may be positioned side-by-side such that the compartment doors 12 of each of these units 61, 62, 63 face in the same direction 67 opposite the first wall 58. The first, second, and third dispensing units 61, 62, 63 may be placed such that the side 38 of the first unit 61 is in the same plane as the second wall 59. The second wall 59 is perpendicular to the first wall 58 such that the first and second walls 58, 59, respectively, form the corner 60. The back 41 of one of the columns 36 of vending compartments 11 in the fourth dispensing unit 64 may be placed against the side 38 of the first dispensing unit 61, whose side 38 is in the same plane as the second wall 59. In this manner, the compartment doors 12 of the fourth dispensing unit 64 may face in a direction 69 opposite the second wall 59 and essentially perpendicular to the direction 67 in which the doors of the first, second, and third units 61, 62, 63 face. As a result, the first, second, third, and fourth dispensing units 61, 62, 63, 64 may be arranged together in a retail display against the two walls 58, 59 around the corner 60.

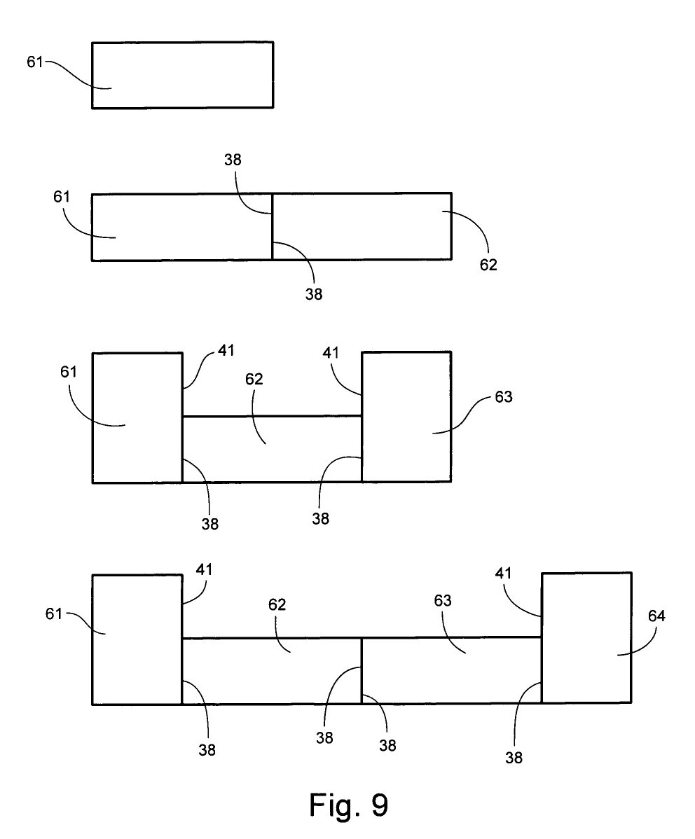

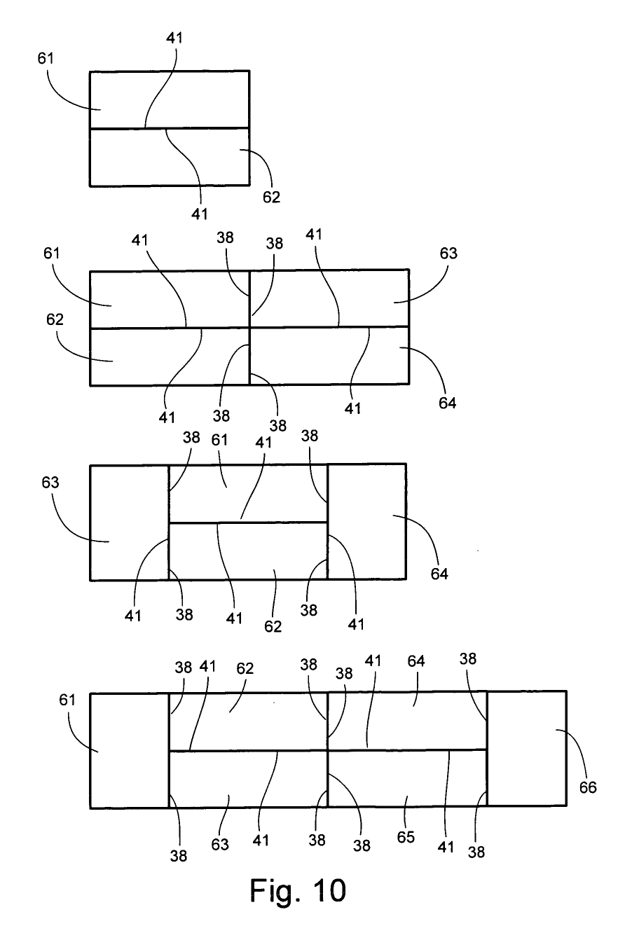

FIGS. 9 and 10 illustrate various configurations of dispensing units 10 comprising two columns 36 of vending compartments 11 that are each one compartment 11 deep. FIG. 9 shows various configurations of from one to four dispensing units 10, that is first, second, third, and fourth dispensing units 61, 62, 63, 64, respectively. For example, first and second dispensing units 61, 62, may be arranged in a side-by-side relationship. Alternatively, the first dispensing unit 61 and the third dispensing unit 63 may each be arranged in a back-to-side relationship with the second dispensing unit 62. In another configuration, the first dispensing unit 61 and the second dispensing unit 62 may be arranged in back-to-side relationship, the third dispensing unit 63 and the fourth dispensing unit 64 may be arranged in back-to-side relationship, and the second dispensing unit 62 and the third dispensing unit 63 may be arranged in side-by-side relationship.

FIG. 10 shows various configurations of from one to six dispensing units 10, that is first, second, third, fourth, fifth, and sixth dispensing units 61, 62, 63, 64, 65, 66, respectively. For example, the first and second dispensing units 61, 62 may be arranged in a back-to-back relationship such that the doors 12 of the compartments 11 in each of these dispensing units 61, 62 face in opposite directions.

In a four unit configuration, the first dispensing unit 61 and the second dispensing unit 62 may be arranged in a back-to-back relationship, and the third dispensing unit 63 and the fourth dispensing unit 64 may be arranged in a back-to-back relationship. In this configuration, the first dispensing unit 61 and the third dispensing unit 63 may be arranged in a side-by-side relationship, and the second dispensing unit 62 and the fourth dispensing unit 64 may be arranged in a side-by-side relationship. As a result, the first, second, third, and fourth dispensing units 61, 62, 63, 64 respectively, may be arranged in a “block” configuration having the doors 12 of the compartments 11 in each dispensing unit 61, 62, 63, 64 facing in a different direction.

In an alternative configuration of four dispensing units 10, the first dispensing unit 61 and the second dispensing unit 62 may be arranged in a back-to-back relationship. The third dispensing unit 63 may be arranged in a back-to-side relationship with the first and second dispensing units 61, 62, and the fourth dispensing unit 64 may also be arranged in a back-to-side relationship with the first and second dispensing units 61, 62. In this configuration, the doors 12 of the compartments 11 in the first and second dispensing units 61, 62 face in opposite directions from each other, and the doors 12 of the compartments 11 in the third and fourth dispensing units 63, 64 face in opposite directions from each other.

In a six unit configuration, the second dispensing unit 62 and the third dispensing unit 63 may be arranged in a back-to-back relationship, and the fourth dispensing unit 64 and the fifth dispensing unit 65 may also be arranged in a back-to-back relationship. In this configuration, the first dispensing unit 61 may be arranged in a back-to-side relationship with the second and third dispensing units 62, 63, and the sixth dispensing unit 66 may be arranged in a back-to-side relationship with the fourth and fifth dispensing units 64, 65 on the side of the configuration opposite the first dispensing unit 61. In this configuration, the doors 12 of the compartments 11 of the second and fourth dispensing units 62, 64 may face in one direction, and the doors 12 of the compartments 11 of the third and fifth dispensing units 63, 65 face in a direction opposite the direction in which the 12 doors of the second and fourth dispensing units 62, 64 face. The doors 12 of the first dispensing unit 61 and the doors 12 of the sixth dispensing unit 66 may face in opposite directions from each other and in directions essentially perpendicular to the directions in which the doors 12 of the compartments 11 of the second, fourth, third, and fifth dispensing units 62, 64, 63, 65 face. As illustrated by the arrangements in FIGS. 9-10, a plurality of dispensing units 10 having two columns 36 of vending compartments 11 may be arranged in various configurations that may be particularly useful in accommodating varied space availabilities in retail settings.

As shown in FIGS. 9-10, various arrangements of dispensing units 10 may provide configurations that avoid creation of a void, or dead space, behind or inside the arrangement, thereby optimizing space utilization in a retail setting. Embodiments in which a void is formed by arrangement of a plurality of dispensing units 10 have advantages as compared to conventional dispensing units having voids formed within the dispensing unit structure. For example, voids formed within conventional dispensing unit structures may utilize materials to manufacture those units that is avoided in embodiments of the present invention. Embodiments of a product dispensing unit 10 of the present invention having less structural materials may thus cost less to manufacture and may be lighter weight and easier to ship and install. In embodiments in which a void is formed by a particular arrangement of a plurality of product dispensing units 10, a roof (not shown) may be added over the void to prevent build-up of refuse or insects, and may maintain the void and dispensing units 10 in cleaner condition.

As shown in FIGS. 7-8, some embodiments of a product dispensing system may include a plurality of modular dispensing units 10 that may be secured together in a retail setting. As shown in FIGS. 2-3, some embodiments of the product dispensing unit 10 may include a plurality of connector slots 70 adapted for connecting individual modular units 10 together. The connector slot(s) 70 may be located on any face of the dispensing unit 10, that is, on the front 42, back 41, sides 38, top 39, and/or bottom 40 of the unit 10. Connector slots 70 on adjacent dispensing units 10 may be aligned, and a connector (not shown) may be inserted into the aligned connector slots 70 to tie the units 10 together. The connector may have various configurations adapted to fit within the connector slots 70 and to pull adjacent dispensing units 10 together and secure the units 10 to each other.

The connector slots 70 may be adapted to hold a connector in the connector slots 70. In certain embodiments, the connector slots 70 may be configured to have a top opening, or receiving portion, 71 sufficiently large to receive the head of a connector. The connector slots 70 may have a lower, or securing, portion 72 extending downward from the top receiving portion 71. In certain embodiments, the lower securing portion 72 may gradually narrow from the top receiving portion 71 to the bottom of the securing portion 72. In other embodiments, the securing portion 72 may include ridges that project slightly into the securing portion 72. In these manners, the securing portion 72 may be adapted to create a bind on the connector as it is forced downward into the lower aspects of the securing portion 72 of the connector slot 70. As a result, modular product dispensing units 70 may be easily pulled together and secured to each other. Securing the units 10 together may decrease space required to display the units 10, provide increased stability to the individual units 10, and decrease any likelihood of unauthorized removal of the units 10 from the display site.

In an alternative embodiment, a first product dispensing unit may include one or more connector slot(s), and a second product dispensing unit may include one or more connector stud(s) (not shown) extending outwardly from an outer surface of the second dispensing unit. The connector stud(s) may be located in positions on the second dispensing unit corresponding to the location(s) of the connector slot(s) on the first dispensing unit. As such, the connector slot(s) on the first dispensing unit may be aligned with the connector stud(s) on the second dispensing unit. The connector stud(s) may then be connected to the connector slot(s) to pull the first and second dispensing units together and secure the units to each other.

Some embodiments of a product dispensing unit 10 may include four vending compartments 11 (as shown in FIG. 1), and some embodiments may include six vending compartments 11 (as shown in FIGS. 7-8). Embodiments of product dispensing units 10 comprising a limited number of vending compartments 11, such as four or six compartments 11, may have advantages over product dispensing units 10 unitarily constructed having larger numbers of compartments 11. For example, as described herein with reference to FIGS. 9-10, such embodiments having smaller numbers of vending compartments 11 may be modular and thus arranged in various configurations. Some embodiments of the product dispensing unit 10, for example, those having four vending compartments 11 and those having six vending compartments 11 shown in FIGS. 1 and 7-8, respectively, may have dimensions less than four feet wide and less than three feet deep. Such smaller, modular product dispensing units 10 may be easier to ship and/or deliver to a retail site than larger units 10. For example, due to their overall size and weight, larger conventional product dispensing units may require shipping on a large truck with a lift gate. However, embodiments of the smaller, modular product dispensing unit 10 of the present invention may be moved by one person with a set of hand trucks, and may be transported in a pick-up truck. Due to a smaller overall size and weight, embodiments of the dispensing unit 10 of the present invention may decrease the risk of injury to personnel and property during shipping, assembly, and installation.

In addition, the modularity of embodiments of a product dispensing unit 10 of the present invention may decrease the time and expense related to repair and/or refurbishing of an arrangement of product dispensing units 10. For example, when modular dispensing units 10 are connected to each other, only the unit 10 in need of repair and/or refurbishing may be disconnected and removed for repair and/or refurbishing, rather than removing the entire arrangement.

In some embodiments, components of the product dispensing unit 10 may be constructed utilizing a plurality of “channel” bars 73, comprising, for example, a metal material extruded or molded into a channel configuration, as shown in FIG. 3. The channel bar 73 may include one or more connector stud(s) (not shown) that may be inserted into connector slot(s) 70 in the frame 44 of the dispensing unit 10. For example, the frames 44 of two side 38 panels of the dispensing unit 10 may be connected together by inserting the connector stud on each end of the channel bar 73 into one of the channel slots 70 in each frame 44. Various portions of the product dispensing unit 10 may be assembled in this fashion. In this way, the dispensing unit 10 may be assembled using fewer separate connecting elements (such as bolts and nuts), which may decrease the cost of materials. In addition, due to the interconnectability of some components of the dispensing unit 10 with channel bars 73 and with fewer parts to assemble, the number of tools needed and the time required to assemble the unit 10 may be decreased.

In another embodiment of the consumer product dispensing unit 10, for example as shown in FIGS. 11-13, the dispensing unit 10 may have a rectangular shape and include 15 vending compartments 11. The dispensing unit 10 shown in FIGS. 11-13 has nine compartments 11 accessible from the wider front 42 of the dispensing unit 10 and three compartments 11 accessible on each of the sides 38 of the dispensing unit 10 for a total of 15 compartments. Various other product dispensing unit sizes, geometric configurations, and arrangements are possible, depending on factors such as available display space and anticipated use.

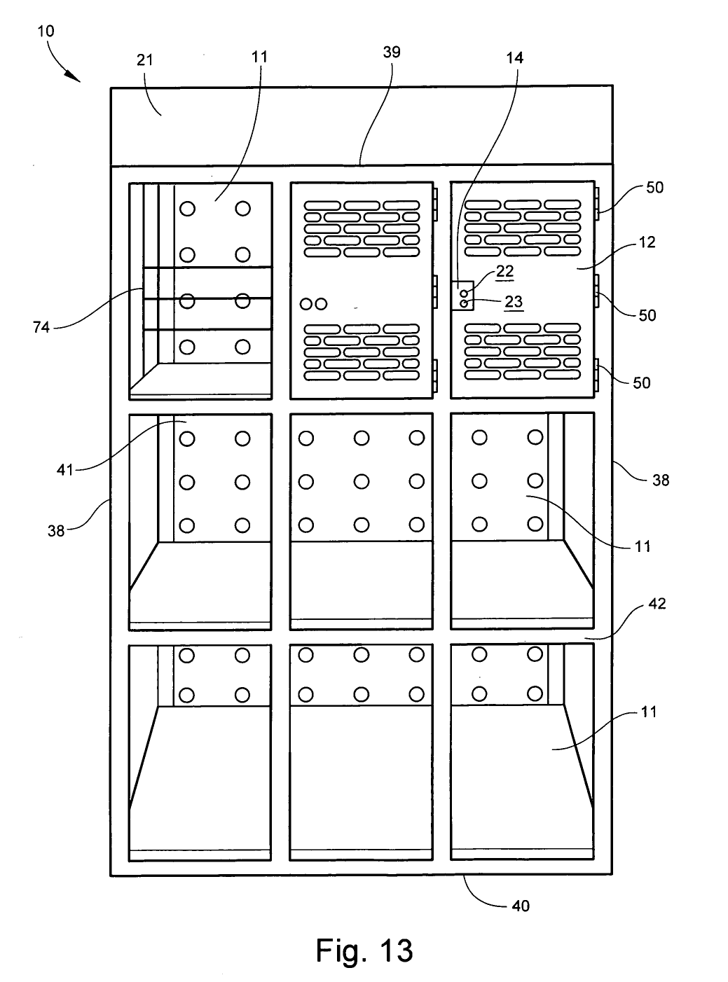

As shown in FIG. 13, in certain embodiments, the back 41 of each vending compartment 11 may be constructed to have an open or partially open, yet secure, structure. In the embodiment shown in FIG. 13, the back 41 of a vending compartment 11 on the front 42 of the dispensing unit 10 may form the side of a compartment 11 on the side 38 of the dispensing unit 10. The common wall, or partition, 74 between compartments 11 may comprise, for example, a series of metal rods or a metal mesh wall to form an open, secure structure. Because a customer may access only one of the vending compartments 11 through each compartment door 12, such a configuration may provide security over product inventory. In addition, such an open configuration may allow air to circulate through the dispensing unit 10 and allow gas to escape from individual compartments 11 and from the dispensing unit 10, if necessary. Moreover, insects such as bees may escape from the dispensing unit 10 and not be trapped in a vending compartment 11.

In embodiments of a key capture mechanism 14 useful in a consumer product dispensing system, components of such a mechanism 14 may be manufactured for durability. In an embodiment, each customer key 24 may be constructed to have a shaft 76 and a handle 75 that are thicker than a typical door key so as to prevent the key 24 from being broken either by customers or vandals. In some embodiments, customer keys 24 may be made from a unique blank so that they may not be easily copied. In other embodiments, the locks 22, 23 may be designed to operate reliably in all outdoor weather conditions where dispensing units 10 may be placed. Some embodiments of the key capture apparatus 14 may be designed to be modular, or removable from the dispensing units 10, such that the locks 22, 23 may be replaced in the field as needed.

In some embodiments, the customer key 24 may be configured to open any of the individual compartments 11 in a particular vending unit 10. In this way, the customer may choose from among compartments 11 having an exchange or replacement product available for access and retrieve the product. Because a compartment 11 that has already been accessed by a previous customer may have the key 24 captured in the door 12 of that compartment 11, or some other indication of non-availability, subsequent customers may readily determine which compartments 11 are available for accessing and retrieving a product. Such a choice of compartments 11 may provide customers the benefit of using a compartment 11 better suited for their height and ability to remove heavier products, such as a tank full of compressed gas. For example, a shorter or less physically able person may choose to use a compartment 11 near the bottom 40 of the vending unit 10. In addition, customers may have preferences for a product in a particular compartment 11. As an example, a customer may prefer the appearance of one compressed gas tank 13 rather than that of another tank 13. As such, customer choice of vended products as provided by some embodiments of the present invention may increase customer satisfaction.

In certain embodiments, the customer keys 24 may be configured to unlock the locks 22 in each dispensing, or vending, unit 10 in use by a particular retail chain store. For example, the keys 24 for compartments 11 in a vending unit 10 at one store in a chain may be configured to unlock the compartments 11 n another vending unit 10 located at the same store or at another store in the chain. Alternatively, or in addition, the customer keys 24 may be configured differently for vending units 10 between retail chains. Accordingly, only the customer keys 24 configured for a particular retail chain may be used to unlock the locks 22 in vending units 10 in use by that chain of stores. In certain embodiments, the retail master key 25 may also be configured to unlock only the locks 23 in vending units 10 utilized by a particular retail chain. In this way, the number of key configurations needed by a retail chain may be limited, and the same keys 24, 25 may be used at any store within a particular retail chain. In addition, the risk that a key from one retail chain might be used to access a vending unit 10 at a different retail chain may be eliminated.

In another aspect of the present invention, some embodiments of a consumer product dispensing system may include a means for monitoring inventory levels of the consumer product dispensed at a location remote from a point of sale. For example, a retail store may be have the same number of customer keys 24 as compartments 11 in a vending unit 10. As sales are made of the product in the vending compartments 10 and a customer key 24 is provided to customers for each sale, unused customer keys 24 may remain at the point of sale, for example, at a store check-out counter. The remaining number of customer keys 24 at the sales location may represent the number of units of consumer product remaining in the vending unit 10. In this manner, the retail store may monitor the level of its remotely-located consumer product inventory simply by observing the number of customer keys 24 at the point-of-sale location. When the retail store inventory of the consumer products reaches a level that warrants re-stocking by the product vendor, store personnel may notify the vendor.

In a particular embodiment of a consumer product dispensing system, a customer may obtain a bar-coded ticket (not shown) from a store display and present the ticket at a check-out counter to pay for the purchase transaction. In such an embodiment, the bar code may be scanned by the store clerk, and the scanned information may be transmitted electronically to the product vendor, for example, through a phone line or cellular transmission or by an automated e-mail system. In this way, inventory levels of the remotely-located consumer product(s) at the retail store may be automatically monitored by both the retail store and the product vendor.

Product inventory in a consumer product dispensing system may need to be replenished from time to time. To replenish product inventory in an embodiment in which the single use access mechanism comprises a key capture system 14, a vendor representative may obtain the retail master key 25 from a store clerk. Alternatively, the vendor representative may have a duplicate retail master key 25. Once at a vending unit to be replenished, the vendor representative may identify a customer lock 22 containing a captured customer key 24. The representative may then insert the retail master key 25 into the retail lock 23 adjacent the customer lock 22 with the captured customer key 24. The representative may unlock the retail lock 23, thereby unlocking the customer lock 22 and releasing the customer key 24. The released customer keys 24 may then be returned to the point of sale or the store clerk.

To replenish product inventory in an embodiment as shown in FIGS. 1-3 and 7-8, in which individual vending compartment inner doors 12 are containing within outer doors 30, a vendor representative may use a key to open the outer door locks 49 and access each of the vending compartments 11. If an exchanged product, such as a compressed gas tank 13, has been placed in the compartment 11 by a customer, the representative may remove the tank 13. The empty compartment 11 may then be replenished with a full tank 13. If there is no exchange tank 13 in the compartment 11, a full tank 13 may be placed in the empty compartment 11.

To replenish product inventory in an embodiment as shown in FIGS. 11-12, in which each vending compartment 11 may be accessed only via its individual door 12, a vendor representative may insert the retail master key 25 into one of the retail locks 23 adjacent a customer lock 22 with a captured customer key 24. The representative may unlock the retail lock 23 to unlock the customer lock 22, release the customer key 24, and open the compartment door 12. If an exchanged tank 13 has been placed in the compartment 11 by a customer, the representative may remove the tank 13. The empty compartment 11 may then be replenished with a full tank 13. If there is no exchange tank 13 in the compartment, a full tank 13 may be placed in the empty compartment 11. This process may be repeated for each of the doors 12 in which a customer key 24 is captured in the customer lock 22.

The vendor representative may remove the exchanged tanks 13 from the premises of the retail store location for re-filling and reuse. At the time of replenishing the vending unit 10, the representative may clean and otherwise service the vending unit 10 as needed, update inventory control information, generate wholesale sales tickets, and/or provide other services related to the consumer product and dispensing system. If the representative has used the retail master key 25 from the retail store, the representative may then return the master key 25 to the store clerk.

When customer keys 24 are released from the customer locks 22 by unlocking the adjacent retail locks 23, the doors 12 may be locked and the customer locks 22 reset so that they may be opened by a subsequent customer. In some embodiments, when the retail lock 23 is actuated to unlock the customer lock 22 and the customer key 24 is removed, the customer lock 22 may be automatically reset and available for use by customers.

In certain embodiments, the dispensing unit 10 may be configured to have one or more service entry door(s) (not shown) separate from individual vending compartment doors 12. In some embodiments, the outer door(s) 30 may comprise a service entry door(s). In such configurations, each of the compartments 11 may be accessed through the service entry door. The service door may be locked and may be keyed to the retail master key 25 or to a separate vendor key. A single service entry door may allow servicing of the entire dispensing unit 10 at one time, including removing exchanged return tanks 13, replenishing the compartments 11 with full tanks 13, and otherwise servicing the dispensing unit 10.

Embodiments of the present invention may be utilized for vending tanks 13 of compressed gas other than propane. For example, the compressed gas product may be carbon dioxide or other compressed gas sold in relatively small quantities. Embodiments of the present invention may be utilized for vending consumer products other than compressed gas tanks 13. A single use access system, such as a key-capture vending system, according to the present invention may facilitate dispensing of products remotely from the point of sale and/or products that are relatively large, heavy, or otherwise difficult to handle. Such products may be dispensed near a customer pick-up location, for example, in a parking lot or near a boat. In another embodiment, for example, each of a plurality of a supply of golf balls may be contained in one of a plurality of compartments 11 in a vending unit 10 near a driving range. The driving range and vending unit 10 may be at a location remote from the point of sale, for instance, at a distance from a golf course club house.

An embodiment of the present invention may include a method for dispensing and/or exchanging a consumer product. For example, in one embodiment of a method for dispensing a tank 13 of compressed gas, a retail store clerk may verify whether a customer has a return tank 13 to exchange and may charge the customer either the price for exchange for a full tank 13 of gas or for the purchase of a full tank 13, including the tank 13. Upon receiving payment, the store clerk may give the customer a single use access mechanism actuating element, such as the customer key 24, to access a full tank 13 from the dispensing unit 10 located remotely from the point of sale, such as outside a store. The dispensing unit 10 may include a plurality of individual compartments 11, each containing a full tank 13. Each compartment may be accessible through a separate locked door 12.

In some embodiments of a method, the dispensing unit 10 may include a single use access mechanism. For example, each compartment door 12 may include a key capture lock system 14 that captures the customer key 24 after the door 12 is unlocked. The key 24 may be used only once by a customer, thereby allowing the customer a one-time access to a single compartment 11. The key 24 may be released via a key release mechanism 15 by an authorized person, such as a store clerk or the product vendor, so that the key 24 and the compartment 11 may be used by a subsequent consumer. In certain embodiments, the key capture system 14 may comprise a dual lock key capture mechanism 26. In such an embodiment, the key release mechanism 15 may include a retail lock 23 adjacent the customer lock 22, and the retail lock 23 may be unlocked by a retail key 25. The retail key 25 may be a master key that may unlock the retail locks 23 on each of the vending compartment doors 12. The retail key 25 may be utilized by a store clerk for assisting in a product sales transaction, if needed. In addition, a vendor representative may use the retail key 25 to replenish the vending unit 10 with full tanks 13 and/or otherwise service the vending unit.

Embodiments of a consumer product dispensing system and/or method according to the present invention may provide advantages over conventional systems and methods. For example, one advantage is that such a system may provide a low cost means for efficiently vending products from a secure area located remotely from the point of sale/purchase. Some embodiments of a consumer product dispensing system and/or method may be useful for receiving and distributing consumer products that may need to be located away from a point of sale, for example, a gas tank 13 stored outside a retail store. Another advantage of a single use access system, such as a key-capture system 14, is that it may provide reliable inventory control of consumer products. An advantage of a mechanically operated consumer product dispensing system is that it may decrease or eliminate the risk of explosion due to sparks created by electronic components used in an electronic vending system. Another advantage of embodiments of a consumer product vending system is that such a system may allow customer selection of product access within a vending unit 10, thereby allowing customers to choose a compartment 11 suited to their ability to remove heavier products. Certain embodiments of the present invention may provide the advantage of variable configurations of product vending units 10. As a result, such vending units 10 may be placed in a variety of locations relative to another structure, such as a building, and may be placed closer to a customer pick-up location, for example, in a parking lot.

Although the present invention has been described with reference to particular embodiments, it should be recognized that these embodiments are merely illustrative of the principles of the present invention. Those of ordinary skill in the art will appreciate that a consumer product dispensing system and method of the present invention may be constructed and/or implemented in other ways and embodiments. Accordingly, the description herein should not be read as limiting the present invention, as other embodiments also fall within the cope of the present invention.

what is claimed is:

1. A system, comprising:
a product dispensing unit comprising a plurality of vending compartments, each compartment accessible through a separate door secured with a lock;
a single use access mechanism that allows a customer to unlock the lock for a one-time access to one of the vending compartments; and
a lock reset mechanism adapted to reset the lock to allow subsequent use of the lock and access to that vending compartment.

2. The system of claim 1, wherein the single use access mechanism further comprises a single use access mechanism actuating element obtainable at a location remote from the dispensing unit.

3. The system of claim 1, the single use access mechanism further comprising a key capture lock system and the single use access mechanism actuating element further comprising a key, wherein once the key is used to unlock the lock on one of the doors, the key is captured in the lock until the lock is reset.

4. The system of claim 3, wherein the key capture lock system further comprises a single lock key capture mechanism.

5. The system of claim 3, wherein the key capture lock system further comprises a dual lock key capture mechanism comprising
a customer lock adapted to capture a first, customer key once the customer key is used to unlock the customer lock and the door, and
a retail lock adapted to cooperate with the customer lock to capture the customer key and to operate with a second, retail key to reset the customer lock and release the customer key.

6. The system of claim 5, wherein the customer key is configured to unlock the door of each of the vending compartments in the dispensing unit.

7. The system of claim 5, wherein the retail key is configured to unlock the door of each of the vending compartments in the dispensing unit.

8. The system of claim 1, wherein the single use access mechanism further comprises a magnetically operated lock.

9. The system of claim 1, wherein the single use access mechanism further comprises a card reader system.

10. The system of claim 1, wherein the single use access mechanism further comprises a numerical key system and a keypad adapted to accept a numerical code for unlocking the lock.

11. The system of claim 1, wherein the reset mechanism is adapted to reset the lock on the door of each of the plurality of vending compartments simultaneously.

12. The system of claim 1, wherein the lock reset mechanism comprises a radio frequency identification mechanism.

13. The system of claim 9, wherein the lock reset mechanism comprises a master code adapted to reset the numerical key system to accept new codes for accessing one or more compartments in the dispensing unit.

14. The system of claim 1, further comprising an inventory control system.

15. The system of claim 5, further comprising an inventory control system, wherein the inventory control system comprises the same number of customer keys as vending compartments in the dispensing unit such that observation of the number of customer keys at the location remote from the dispensing unit provides a means for monitoring product inventory levels in the dispensing unit.

16. The system of claim 14, wherein the inventory control system comprises a bar-coded ticket adapted to be electronically scanned upon purchase of a product.

17. The system of claim 1, the product dispensing unit further comprising:
a closed top, bottom, back, and two sides;
an open front;
two columns of the vending compartments;
a depth substantially the same as a single vending compartment depth; and
an outer door comprising a frame hingedly connected on each side of the front of the dispensing unit, each outer door closeable and lockable about one of the columns of vending compartments, wherein
the separate compartment doors further comprise a plurality of inner doors, each inner door adapted to cover one of the vending compartments in one of the columns, hingedly connected to the outer door lockable about that column, and openable and closeable while the outer door is locked.

18. The system of claim 1, further comprising a plurality of the product dispensing unit, each of the product dispensing units adapted to be arranged together in a variety of modular operational configurations.

19. The system of claim 18, wherein at least one of the dispensing units is connectable to at least one other of the dispensing units, and wherein the vending compartment doors of the at least one dispensing unit face in a different direction than the vending compartment doors of the at least one other dispensing unit.

20. The system of claim 19, wherein each dispensing unit further comprises one or more connector slots adapted for securely connecting one or more of the dispensing units together with a connector.

21. The system of claim 1, wherein the dispensing unit further comprises an assembly of components interconnected with a plurality of channel bars.
